(19) United States
(12) Patent Application Publication
(10) Pub. No.: US 2016/0006233 A1
(43) Pub. Date: Jan. 7, 2016

(54) TERMINATED COVERED ELECTRIC WIRE

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Naoyuki OSHIUMI, Yokkaichi-shi (JP); Shigeyuki TANAKA, Yokkaichi-shi (JP); Kazuo NAKASHIMA, Yokkaichi-shi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 14/772,114

(22) PCT Filed: Jan. 15, 2014
(86) PCT No.: PCT/JP2014/050492

§ 371 Date: Sep. 2, 2015

(30) Foreign Application Priority Data
Mar. 22, 2013 (JP) 2013-059255

(51) Int. Cl. H02G 15/22; H01B 7/28

(52) U.S. Cl. CPC H02G 15/22; H01B 7/2806

(57) ABSTRACT

A terminated covered electric wire having an excellent anticorrosive performance even after thermal shock is provided. An electrical connection portion in which a terminal fitting having a surface to which processing oil adheres and an electric wire conductor of a covered electric wire are electrically connected to each other is covered with an anticorrosive agent containing a resin and an oil-adsorbing filler to configure a covered electric wire with a terminal.

### TECHNICAL FIELD

The present invention relates to a covered electric wire with a terminal (terminated covered electric wire), and more specifically to a terminated covered electric wire in which an electrical connection portion between an electric wire conductor and a terminal fitting has an excellent anticorrosive performance.

### BACKGROUND ART

A terminal fitting is connected to an electric wire conductor at an end of a covered electric wire to be arranged in a vehicle such as an automobile. For example, Patent Document 1 discloses a technology for injecting grease into a connector into which the terminal fitting connected to the electric wire conductor is inserted to be locked thereto in order to prevent corrosion in an electrical connection portion in which the electric wire conductor of the covered electric wire and the terminal fitting are electrically connected to each other.

### CITATION LIST

### Patent Documents

Patent Document 1: JP H05-159846A

### SUMMARY OF THE INVENTION

### Technical Problem

In recent years, in order to reduce the weight of a vehicle such as an automobile, the use of aluminum or an aluminum alloy as a material of the electric wire conductors has been considered. On the other hand, copper or a copper alloy is often used as a material of terminal fittings. In addition, the surface of the terminal fittings is often plated with tin or the like. That is, the material of the electric wire conductor and the material of the terminal fitting may be different from each other. If the material of the electric wire conductor and the material of the terminal fittings are different from each other, corrosion occurs in the electrical connection portion therebetween due to the contact between different metals. Therefore, it is required to reliably prevent corrosion in the electrical connection portion.

Here, in general, the terminal fitting is shaped into a predetermined shape by pressing using processing oil. The processing oil may also be used when the terminal fitting is crimped to the electric wire conductor. The processing oil used during the processing remains on the surface of the terminal fitting. Since the residual processing oil serves as coating to protect the surface of the terminal fitting against corrosion, it is preferable that the processing oil remains on the surface of the terminal fitting from the viewpoint of preventing corrosion.

However, when the electrical connection portion between the electric wire conductor and the terminal fitting is covered with an anticorrosive agent in order to prevent the corrosion of the electrical connection portion, if a resin-containing anticorrosive agent is used, the anticorrosive performance after thermal shock may be deteriorated, unlike in the case where an anticorrosive agent having an excellent fluidity, such as grease, is used.

It is an object of the present invention to provide a terminated covered electric wire having an excellent anticorrosive performance even after thermal shock.

### Solution to Problem

In order to solve the foregoing problems, a terminated covered electric wire according to the present invention has an electrical connection portion in which a terminal fitting having a surface to which processing oil adheres and an electric wire conductor of a covered electric wire are electrically connected to each other, the electrical connection portion being covered with an anticorrosive agent containing a resin and an oil-adsorbing filler.

In this case, it is preferable that the oil-adsorbing filler is contained in the anticorrosive agent in an amount in a range of 0.5 to 25 mass %. Moreover, it is preferable that the amount of oil adsorbed by the oil-adsorbing filler, which is measured based on JIS K 5101, is 10 ml/100 g or more. It is preferable that the oil-adsorbing filler is at least one selected from carbon black, silica, calcium carbonate, calcium silicate, magnesium hydroxide, and talc. It is preferable that the resin contained in the anticorrosive agent is at least one selected from an epoxy resin, a polyamide resin, an acrylic resin, a urethane resin, and a silicone resin.

### Advantageous Effects of the Invention

With the terminated covered electric wire according to the present invention, the oil-adsorbing filler contained in the anticorrosive agent adsorbs the processing oil adhering to the surface of the terminal fitting and the resin contained in the anticorrosive agent easily adheres to the metal on the surface of the terminal fitting, and therefore, an excellent anticorrosive performance is maintained even after thermal shock.

In this case, if the oil-adsorbing filler is contained in the anticorrosive agent in an amount in a range of 0.5 to 25 mass %, an effect of adsorbing the processing oil is increased. Moreover, an increase in viscosity of the anticorrosive agent is suppressed, and ease of permeation to the minute portions of the terminal fitting and the electric wire conductor in the electrical connection portion is maintained.

If the oil-adsorbing filler adsorbs oil in equal to or greater than a specific amount, the oil-adsorbing filler mixed even in a small amount can exhibit a high oil-adsorbing effect. Accordingly, both an excellent oil-adsorbing effect and an excellent permeability can be achieved.

### BRIEF DESCRIPTION OF DRAWINGS

FIG. 1 is a perspective view of the exterior of an example of a terminated covered electric wire according to the present invention.

FIG. 2 is a longitudinal cross-sectional view taken along line A-A in FIG. 1.

### DESCRIPTION OF EMBODIMENTS

Hereinafter, an embodiment of the present invention will be described in detail using the drawings.

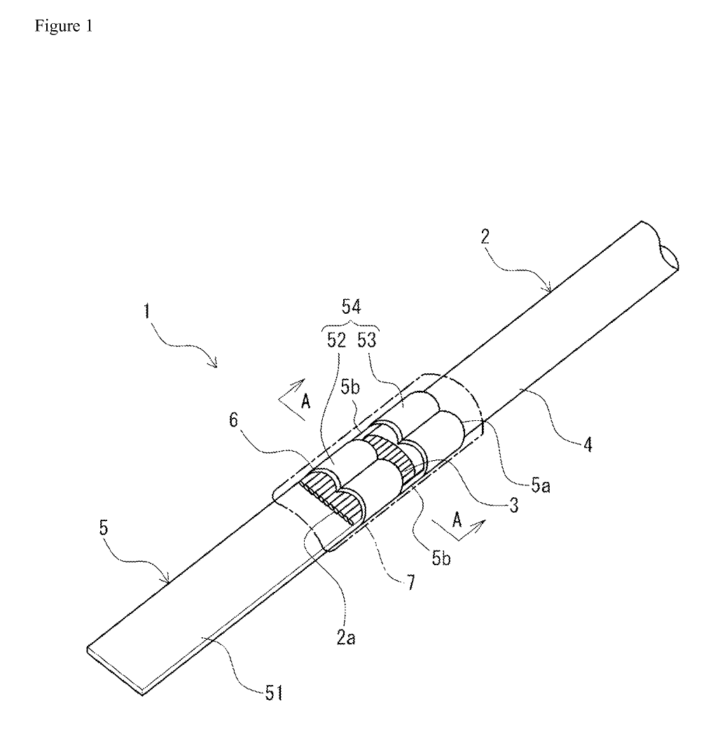

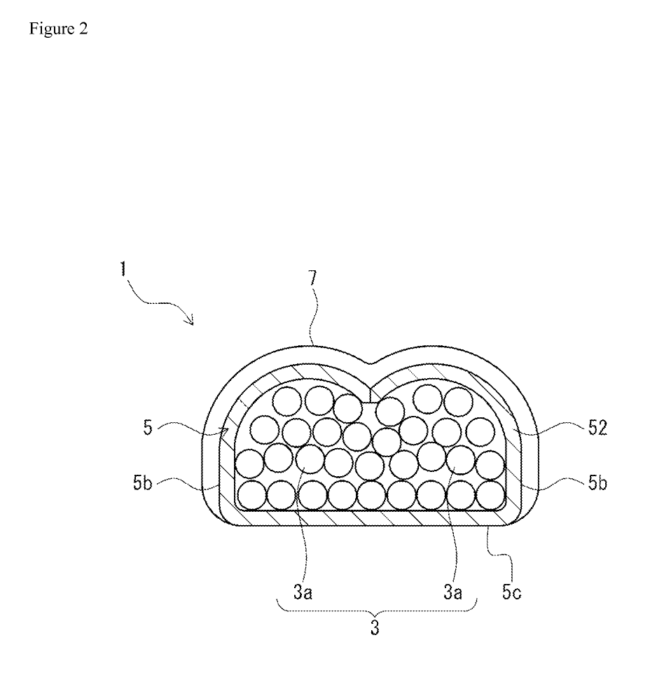

FIG. 1 is a perspective view illustrating the exterior of an example of a terminated covered electric wire according to the present invention, and FIG. 2 is a longitudinal cross-sectional view taken along line A-A in FIG. 1. As shown in FIGS. 1 and 2, in a terminated covered electric wire 1 according to the present invention, a covered electric wire 2 includes an electric wire conductor 3 covered by an insulator 4, and the electric wire conductor 3 of the covered electric wire 2 is electrically connected to a terminal fitting 5 in an electrical connection portion 6.

The terminal fitting 5 includes a tab-shaped connecting portion 51 constituted by an elongated plate to be connected to a partner terminal, and an electric wire fixing portion 54 constituted by a wire barrel 52 and an insulation barrel 53 that extend from the end portion of the connecting portion 51.

In the electrical connection portion 6, the electric wire conductor 3 is exposed by peeling the insulator 4 at the end of the covered electric wire 2, and the covered electric wire 2 and the terminal fitting 5 are connected to each other by crimping this exposed electric wire conductor 3 to the terminal fitting 5 on one surface side. The electric wire conductor 3 and the terminal fitting 5 are electrically connected by crimping the wire barrel 52 of the terminal fitting 5 over the electric wire conductor 3 of the covered electric wire 2. In addition, the insulation barrel 53 of the terminal fitting 5 is crimped over the insulator 4 of the covered electric wire 2.

The terminal fitting 5 is shaped (processed) into a predetermined shape by pressing a metal plate. A processing oil such as a hydrocarbon-based processing oil is used during the pressing. Accordingly, the processing oil remains on (adheres to) the surface of the terminal fitting 5 just after the terminal fitting 5 is shaped. Furthermore, the processing oil may also be used during crimping (processing). In this case, the processing oil remains on (adheres to) the surface of the terminal fitting 5 just after the terminal fitting 5 is crimped. The processing oil also remains on (adheres to) the surface of the electric wire conductor 3 just after the electric wire conductor 3 undergoes the crimping, similarly to the terminal fitting 5. The processing oil adheres thereto in an amount of about 0.2 to 1 mg/cm².

It should be noted that the amount of the processing oil adhering to the surface of the terminal fitting 5 can be determined by extracting the processing oil using a solvent in which the processing oil is easily dissolved and by measuring the amount of the processing oil in the solvent using absorption spectrophotometry or the like. If a hydrocarbon-based processing oil is used, one example of the solvent in which the processing oil is easily dissolved is a hydrocarbon-based solvent such as hexane.

The range shown by the dashed-dotted line in FIG. 1 of the electrical connection portion 6 is covered with an anticorrosive agent 7 in a state in which the processing oil adheres to the surface of the terminal fitting 5. It should be noted that in the electrical connection portion 6 in FIG. 1, the anticorrosive agent 7 is shown in a transparent manner. The anticorrosive agent 7 prevents infiltration of moisture and the like from the outside into the electric wire conductor 3, a portion in which the electric wire conductor 3 and the terminal fitting 5 are in contact with each other, and the like, and corrosion of metal parts.

The specific portions covered with the anticorrosive agent 7 are described below. As shown in FIG. 1, the covered electric wire 2 on a front end 2a side is covered with the anticorrosive agent 7 such that the anticorrosive agent 7 slightly protrudes toward a side of the connecting portion 51 of the terminal fitting 5 from the front end of the electric wire conductor 3. The terminal fitting 5 on a front end 5a side is covered with the anticorrosive agent 7 such that the anticorrosive agent 7 slightly protrudes toward a side of the insulator 4 of the covered electric wire 2 from the end portion of the insulation barrel 53. As shown in FIG. 2, side surfaces 5b of the terminal fitting 5 are also covered with the anticorrosive agent 7. A back surface 5c of the terminal fitting 5 is not covered with the anticorrosive agent 7. In this manner, the electrical connection portion 6 is covered with the anticorrosive agent 7 with a predetermined thickness along the outer peripheral shapes of the terminal fitting 5 and the covered electric wire 2. A portion from which the electric wire conductor 3 is exposed by peeling the end of the covered electric wire 2 is completely covered with the anticorrosive agent 7, and thus is not exposed to the outside. It should be noted that the back surface side of the electric wire fixing portion 54 of the terminal fitting 5 (including the back surface sides of the wire barrel 52 and the insulation barrel 53) may also be covered with the anticorrosive agent 7 as long as there is no influence on the electrical connection.

Accordingly, three sides of the lateral ends of the anticorrosive agent 7 with which the electrical connection portion 6 is covered are in contact with the surface of the terminal fitting 5 and one end thereof is in contact with the surface of the insulator 4. That is, most of the lateral ends of the anticorrosive agent 7 is in contact with the surface of the terminal fitting 5.

Here, the processing oil on the surface of the terminal fitting 5 causes a gap between the surface of the terminal fitting 5 and the anticorrosive agent 7. If the terminal fitting 5 is distorted due to thermal shock, the size of this gap is increased. If the gap reaches the electrical connection portion 6, moisture and the like infiltrate the electrical connection portion 6 from the outside, and corrosion of metal parts progresses. In order to prevent such a case, in the present invention, a specific agent is used as the anticorrosive agent 7.

The anticorrosive agent 7 contains a resin and an oil-adsorbing filler. The oil-adsorbing filler contained in the anticorrosive agent 7 adsorbs the processing oil adhering to the surface of the terminal fitting 5 and the resin contained in the anticorrosive agent 7 easily adheres to the metal on the surface of the terminal fitting 5. Therefore, an excellent anticorrosive performance is maintained even after thermal shock.

The oil-adsorbing filler contained in the anticorrosive agent 7 may be an inorganic filler or an organic filler. Specific examples of the oil-adsorbing filler include carbon black, silica, calcium carbonate, calcium silicate, nylon microparticles, magnesium hydroxide, and talc. These fillers may be used alone or in combination of two or more.

The oil-adsorbing filler is a type of fillers, and exhibits an viscosity increasing effect when being mixed. If the oil-adsorbing filler is contained in a large amount, ease of permeation to the minute portions of the terminal fitting 5 and the electric wire conductor 3 in the electrical connection portion 6 decreases due to an increase in viscosity, and thus the application properties of the anticorrosive agent 7 decreases. Accordingly, from the viewpoint that an increase in the viscosity of the anticorrosive agent 7 is suppressed and ease of permeation to the minute portions of the terminal fitting 5 and the electric wire conductor 3 in the electrical connection portion 6 is maintained, the oil-adsorbing filler is preferably contained in the anticorrosive agent 7 in an amount of 25 mass % or less, and more preferably in an amount of 20 parts by mass or less. On the other hand, from the viewpoint that the oil-adsorbing filler has an excellent effect of adsorbing the processing oil, the oil-adsorbing filler is preferably contained in the anticorrosive agent 7 in an amount of 0.5 mass % or more, and more preferably in an amount of 10 parts by mass or more.

Moreover, if the oil-adsorbing filler adsorbs oil in a large amount, the oil-adsorbing filler mixed even in a small amount can exhibit a high oil-adsorbing effect. Accordingly, from the viewpoint that both an excellent oil-adsorbing effect and an excellent permeability (application properties) can be achieved, the oil-adsorbing filler preferably adsorbs oil in an amount of 10 ml/100 g or more, and more preferably 50 ml/100 g or more. The amount of oil adsorbed by the oil-adsorbing filler is measured based on JIS K 5101.

Examples of the resin to be contained in the anticorrosive agent 7 include an epoxy resin, a polyamide resin, an acrylic resin, a urethane resin, and a silicone resin. These resins may be used alone or in combination of two or more. Curable resins of these resins are finally made into cured products. Additives such as a coloring pigment, a viscosity modifier, an antioxidant, an inorganic filler, a preservation stabilizer, and a dispersant may be added to the anticorrosive agent 7.

Examples of the epoxy resin include an epoxy resin made from phenols, such as a bisphenol A type epoxy resin, a bisphenol F type epoxy resin or a bisphenol AD type epoxy resin; an aliphatic type epoxy resin such as alcohols; an epoxy resin made from amines; and a cresol novolak epoxy resin made from an o-cresol novolak resin.

It is preferable that the anticorrosive agent 7 has a viscosity in a range of 1000 to 30000 mPa·s at 25° C. during application because a predetermined amount thereof can be reliably applied. It should be noted that the viscosity is a value measured using a rotational viscometer based on JIS Z 8803.

If the viscosity of the anticorrosive agent 7 is too high, the material has an insufficient fluidity during application, thus making it difficult to fill the anticorrosive agent 7 in a sufficient amount into a predetermined position. In addition, if the viscosity of the anticorrosive agent 7 is too low, the anticorrosive agent 7 flows out during application, thus making it difficult to hold the anticorrosive agent 7 in a sufficient amount at a predetermined position.

It is preferable to apply the anticorrosive agent 7 such that the coating has a thickness in a range of 0.01 to 0.1 mm after application. If the anticorrosive agent 7 forms a too thick coating, there is a risk that a connector is hard to insert into the terminal fitting 5. In addition, if the anticorrosive agent 7 forms a too thin coating, there is a risk that an anticorrosive performance is insufficient.

Any known method such as a dripping, painting or extruding can be used to apply the anticorrosive agent 7. Moreover, the temperature of the anticorrosive agent 7 may be adjusted by heating, cooling, or the like during application. Furthermore, when being applied, the anticorrosive agent 7 may be diluted with a solvent into a liquid form in order to improve the permeability (application properties) of the anticorrosive agent 7.

Hereinafter, components of the terminated covered electric wire 1 will be described.

The electric wire conductor 3 of the covered electric wire 2 is constituted by a stranded wire obtained by twisting a plurality of strands 3a. In this case, the stranded wire may be constituted by a single metal strand or two or more metal strands. Apart from the metal strands, the stranded wire may include a strand or strands made of organic fiber, or the like. It should be noted that “constituted by a single metal strand” means that all of the metal strands constituting the stranded wire are made of the same metal material, and “constituted by two or more metal strands” means that the stranded wire includes metal strands made of metal materials that are different from one another. The stranded wire may include a reinforcement wire (tension member) or the like for reinforcing the covered electric wire.

Examples of the material of the metal strand constituting the above electric wire conductor 3 include copper, a copper alloy, aluminum, and an aluminum alloy, or a material obtained by forming various types of plating on these materials. Moreover, examples of the material of the metal strand serving as the reinforcement wire include a copper alloy, titanium, tungsten, and stainless steel. Furthermore, one example of the organic fiber serving as the reinforcement wire is Kevlar.

Examples of the material of the insulator 4 include rubber, polyolefin, PVC, and a thermoplastic elastomer. These materials may be used alone or in combination two or more. Various additives may be added to the material of the insulator 4 as appropriate. Examples of the additive include a flame retardant, a filler, and a coloring agent.

Examples of the material of the terminal fitting 5 (material of a base material) include various copper alloys and copper in addition to brass, which is commonly used. A portion (e.g., a contact point) of the surface of the terminal fitting 5 or the entire surface of the terminal fitting 5 may be plated with various types of metal, such as tin, nickel or gold.

### WORKING EXAMPLES

Hereinafter, working examples and comparative examples of the present invention will be described. It should be noted that the present invention is not limited to these working examples.

### Working Example 1

### Production of Covered Electric Wire

A polyvinyl chloride composition was prepared by mixing 40 parts by mass of diisononyl phthalate as a plasticizer, 20 parts by mass of calcium bicarbonate as a filler, and 5 parts by mass of a calcium zinc-based stabilizer as a stabilizer to 100 parts by mass of polyvinyl chloride (degree of polymerization of 1300) using an open roll at 180° C., and by shaping the mixture into a pellet form using a pelletizer. Then, the polyvinyl chloride composition was extruded using a 50 mm extruder to cover the periphery of an electric wire conductor (cross-sectional area of 0.75 mm²) constituted by an aluminum alloy stranded wire obtained by twisting seven aluminum alloy strands with a thickness of 0.28 mm. A covered electric wire (PVC electric wire) was produced in this manner.

### Connection of Terminal Fitting

After the end of the covered electric wire was peeled to expose the electric wire conductor, a male terminal fitting (tab width of 0.64 mm) made of brass, which is widely used in automobiles, was crimped to the end of the covered electric wire. It should be noted that the terminal fitting used was processed (shaped/crimped) using processing oil, and hydrocarbon-based processing oil adhered to the surface of the terminal fitting.

### Measurement of Amount of Adhering Processing Oil

Concerning the covered electric wire in which the terminal fitting was crimped and connected to the end thereof (the covered electric wire to which the anticorrosive agent was not applied yet), the amount of the processing oil adhering to the surfaces of the terminal fitting and the electric wire conductor thereof was studied. Specifically, hexane extraction was performed, and the amount of the processing oil dissolved in the hexane was quantified by an absorption spectrophotometry. “UV-8020” available from Tosoh Corporation was used as an absorption spectrophotometer. As a result, the processing oil adhered in an amount of 0.3 mg/cm²

### Production of Terminated Covered Electric Wire

Concerning a covered electric wire that was different from the covered electric wire used in the measurement of the amount of the adhering processing oil and in which the terminal fitting was crimped and connected to the end thereof (the covered electric wire to which the processing oil adhered), the anticorrosive agent was applied onto the electrical connection portion between the electric wire conductor and the terminal fitting to cover the exposed electric wire conductor and the barrels of the terminal fitting. Then, the anticorrosive agent was cured under a predetermined curing condition, and the terminated covered electric wire was produced. It should be noted that the cured anticorrosive agent had a thickness of 0.05 mm.

### Preparation of Anticorrosive Agent

The anticorrosive agent was prepared by mixing a bisphenol F type epoxy resin (“806” available from Mitsubishi Chemical Corporation), a curing agent (“DICY7” available from Mitsubishi Chemical Corporation), a curing accelerator (“NOVACURE 3088” available from Asahi Kasei E-materials Corporation), and 20 parts by mass of carbon black (“KETJENBLACK” available from LION Corporation, DBP adsorption amount of 360 cm³/100 g) as the oil-adsorbing filler.

### Working Example 2

A terminated covered electric wire was produced in the same manner as in Working Example 1, except that carbon black was mixed in an amount of 5 parts by mass in the preparation of the anticorrosive agent.

### Working Example 3

A terminated covered electric wire was produced in the same manner as in Working Example 1, except that talc (“MS-P” available from Nippon Talc Co., Ltd., oil adsorption amount of 28 ml/100 g) was mixed in an amount of 0.5 parts by mass instead of carbon black in the preparation of the anticorrosive agent.

### Working Example 4

A terminated covered electric wire was produced in the same manner as in Working Example 3, except that talc was mixed in an amount of 1.5 parts by mass in the preparation of the anticorrosive agent.

### Comparative Example 1

A terminated covered electric wire was produced in the same manner as in Working Example 1, except that no carbon black was mixed in the preparation of the anticorrosive agent.

The anticorrosive performance of each of the produced terminated covered electric wires was evaluated. In addition, as a reference, an adhesive strength of the anticorrosive agent with respect to tin plating was measured.

### Anticorrosive Performance

A cross section of the terminated covered electric wire 1 was observed. Cases where there was no gap at the interface between the anticorrosive agent and the terminal were evaluated as “Good”, and cases where there was a gap were evaluated as “Poor”. The anticorrosive performance test was evaluated both in the early stage after the anticorrosive agent was cured and after thermal shock. Thermal shock was performed based on JIS C 60068-2-14. Specifically, as one cycle, thermal shock was applied by holding the object at minus 40° C. for 30 minutes and then holding the object at plus 125° C. for 30 minutes. This thermal shock was repeated over 500 cycles.

Adhesive Strength with Respect to Tin Plating

Pressing oil diluted with an organic solvent was dropped in a predetermined amount on the surface of a copper plate that had been plated with tin, the anticorrosive agent was applied and cured under the above conditions, and then the adhesive strength between the surface of tin plating and the cured product of the anticorrosive agent was measured by a method defined in JIS K 6850.

TABLE 1

| | Work. Ex. | | | | Comp. Ex. |
|---|---|---|---|---|---|
| | 1 | 2 | 3 | 4 | 1 |
| Type of oil-adsorbing filler | CB | CB | Talc | Talc | — |
| Content of oil-adsorbing | 20 | 5 | 0.5 | 1.5 | — |
| filler (mass %) | | | | | |
| Anticorrosive performance | Good | Good | Good | Good | Good |
| (early stage) | | | | | |
| Anticorrosive performance | Good | Good | Good | Good | Poor |
| (after thermal shock) | | | | | |
| Adhesive strength with | 14 | 10 | 12 | 12 | 7 |
| respect to tin plating (MPa) | | | | | |

In Comparative Example 1, no oil-adsorbing filler was added to the anticorrosive agent, and therefore, the anticorrosive performance was deteriorated after thermal shock though the electrical connection portion was covered with the anticorrosive agent. In contrast, in the working examples, it was confirmed that the excellent anticorrosive performance of the anticorrosive agent was maintained even after thermal shock by adding the oil-adsorbing filler to the anticorrosive agent. Furthermore, it was confirmed that the adhesive strength between the surface of tin plating and the cured product of the anticorrosive agent was higher in the working examples than in Comparative Example 1.

While the embodiment of the present invention has been described in detail, the present invention is not limited to the above-described embodiment, and various modifications can be made without departing from the gist of the present invention.

1. A terminated covered electric wire comprising:
a covered electric wire including an electric wire conductor; and
a terminal fitting having a surface to which processing oil adheres;
the terminal fitting and the electric wire conductor being electrically connected to each other at an electrical connection portion that is covered with an anticorrosive agent containing a resin and an oil-adsorbing filler.

2. The terminated covered electric wire according to claim 1,
wherein the oil-adsorbing filler is contained in the anticorrosive agent in an amount in a range of 0.5 to 25 mass %.

3. The terminated covered electric wire according to claim 1,
wherein the oil-adsorbing filler is at least one selected from carbon black, silica, calcium carbonate, calcium silicate, magnesium hydroxide, and talc.

4. The terminated covered electric wire according to claim 1,
wherein the resin contained in the anticorrosive agent is at least one selected from an epoxy resin, a polyamide resin, an acrylic resin, a urethane resin, and a silicone resin.

5. The terminated covered electric wire according to claim 2,
wherein the oil-adsorbing filler is at least one selected from carbon black, silica, calcium carbonate, calcium silicate, magnesium hydroxide, and talc.

6. The terminated covered electric wire according to claim 2,
wherein the resin contained in the anticorrosive agent is at least one selected from an epoxy resin, a polyamide resin, an acrylic resin, a urethane resin, and a silicone resin.

7. The terminated covered electric wire according to claim 3,
wherein the resin contained in the anticorrosive agent is at least one selected from an epoxy resin, a polyamide resin, an acrylic resin, a urethane resin, and a silicone resin.

8. The terminated covered electric wire according to claim 5,
wherein the resin contained in the anticorrosive agent is at least one selected from an epoxy resin, a polyamide resin, an acrylic resin, a urethane resin, and a silicone resin.
